(19) United States
(12) Patent Application Publication
(10) Pub. No.: US 2002/0056104 A1
(43) Pub. Date: May 9, 2002

(54) Folder-style program guide with categories and sub-categories

(76) Inventors: Tara Burnhouse, Solana Beach, CA (US); Yuko Nishikawa, La Jolla, CA (US); Dayan Golden, San Diego, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/896,340

(22) Filed: Jun. 28, 2001

Related U.S. Application Data
(60) Provisional application No. 60/215,291, filed on Jun. 30, 2000.

(51) Int. Cl. G09G 5/00

(52) U.S. Cl. 725/39

(57) ABSTRACT

A method and system for generating a folder guide used to generate tailored broadcast system electronic program guides is described. In one embodiment, at least one category folder is displayed. The user can then select a category folder of interest. Sub-category folders related to the selected category are then displayed. The user can then select one or more sub-category folders and generate a category specific electronic program guide automatically.

### BACKGROUND OF THE INVENTION

This application claims the benefit of U.S. Provisional Application No. 60/215,291 filed Jun. 30, 2000.

### ART BACKGROUND

Television broadcasting technology has improved tremendously since its inception. Today, television signals are broadcasted on the airwaves, through cables, and via satellite. The number of stations accessible today has increased to hundreds of stations. To select a program to view, many viewers simply “channel surf” until they find a channel that has a desirable program. Channel surfing refers to the process of using the channel “+” or “−” key to sequentially view each channel. Although some viewers find channel surfing among hundreds of stations enjoyable, most viewers prefer a more direct method for selecting a program to view.

Some prior art television channel selection guides provide a television channel selection guide which displays a listing of the channels typically in numeric order and the titles of the programs broadcasted or to be broadcasted on the channels. The viewer or user of the system may then select the channel by entering in the channel number or selecting a program. The system responds by removing the guide displayed and tuning to the station selected and displaying the broadcast signals of the station.

A viewer is provided with many options regarding programs that are available for broadcast. These options include, but are not limited to, channel surfing among program descriptions while watching a particular program on one channel, on-demand selection of pay-per-view broadcasts, selection of a broadcast for automatic recording, and programming a broadcast system to tune to a preselected station at a designated time. These options are typically accessed through graphical user interfaces. As the number of viewer options increases, so to does the need for a user-friendly system interface. The prior art channel selection guides do not provide ready indications as to the functional areas of the system interface. In addition, as the channel selection guides become more interactive and provide the viewer with more selections, the lack of distinguishing features of interactive portions of the displays can lead to a great deal of viewer frustration.

### SUMMARY OF THE INVENTION

A method and system for generating a folder guide used to generate tailored broadcast system electronic program guides is described. In one embodiment, at least one category folder is displayed. The user can then select a category folder of interest. Sub-category folders related to the selected category are then displayed. The user can then select one or more sub-category folders and generate a category specific electronic program guide automatically.

### BRIEF DESCRIPTION OF THE DRAWINGS

The objects, features, and advantages of the present invention will be apparent to one skilled in the art from the following detailed description in which:

FIG. 1a is a simple illustration of one embodiment of the present invention.

FIG. 1b is a simple illustration of one embodiment of the present invention.

FIG. 2 illustrates an exemplary block diagram representation of elements utilized in receiving television signals, which may be used in accordance with one embodiment of the present invention.

FIG. 3 illustrates exemplary data utilized to present the electronic program guide, which may be used in one embodiment of the present invention.

FIG. 4 illustrates one embodiment of pointers to the data utilized for generating an electronic program guide, which may be used in accordance with one embodiment of the present invention.

FIG. 5 illustrates one exemplary process flow diagram for selecting and generating a display.

FIG. 6 illustrates one embodiment of a program display showing various types of programs and detail information associated with each program.

FIG. 7 illustrates one embodiment of a user channel selection process performed by navigating through a folder-style menu, sub-category folder and program display to generate a program display.

FIG. 8 illustrates one embodiment of a guide menu showing various types of guides and features in a guide menu.

FIG. 9 illustrates one embodiment of a folder-style guide menu showing various types of programming associated with each folder.

FIG. 10 illustrates one embodiment of a sub-category-folder showing various types of sub-categories and programming associated with each subcategory-folder.

### DETAILED DESCRIPTION

In the method and apparatus of the present invention the broadcast system described is a direct broadcast satellite system. However it is readily apparent to one skilled in the art that other broadcast systems and devices which have the capability of receiving and displaying, in a realtime or a time-delay manner, a multiplicity of channels on stations may utilize the method and apparatus of the present invention. Furthermore, in the following description, for purposes of explanation, numerous details are set forth, such as menus, guides, flowcharts, and system configurations, in order to provide a thorough understanding of the present invention. However, it will be apparent to one skilled in the art that the specific details are not required in order to practice the present invention. In other instances, well-known electrical structures and circuits are shown in block diagram form in order not to necessarily obscure the present invention.

It should be noted that additional functions can be added to the process and functions modified or removed and still be within the spirit and scope of the invention. The system provides innovative and user friendly access to information regarding programming available through the broadcasting system.

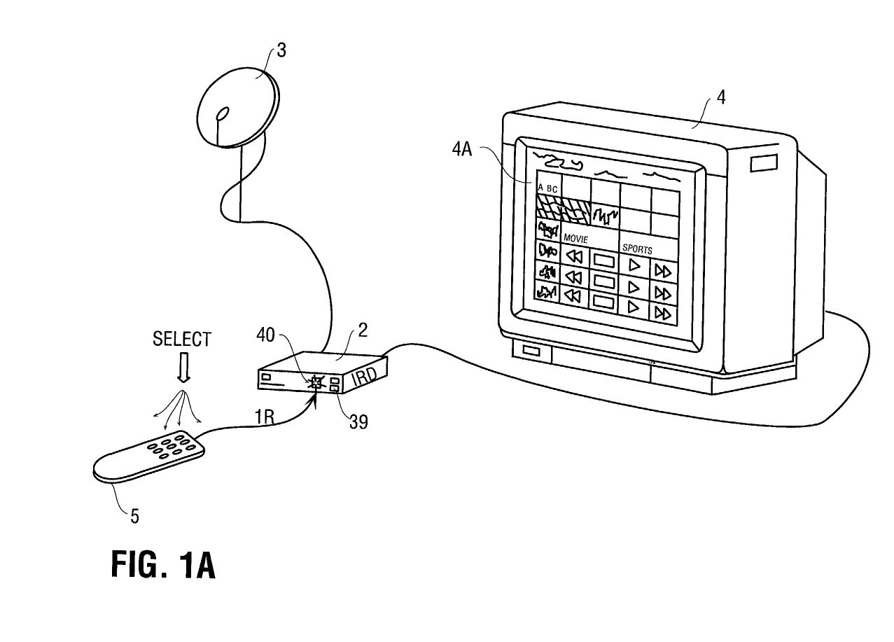

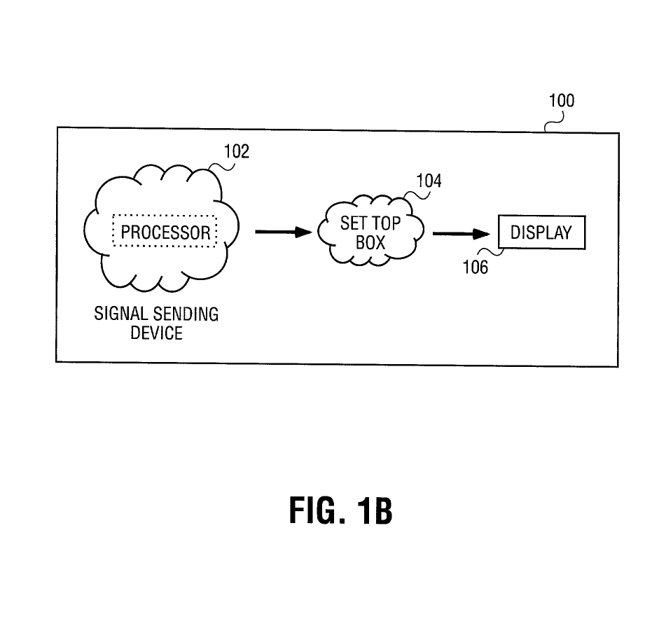

FIG. 1a is a simplified diagram illustrating an embodiment of a Direct Satellite System (DSS) used, in one embodiment, to receive broadcast and broadcast information such as information used to generate the guides discussed herein. The system has an antenna 3, an integrated receiver/decoder IRD 2, a remote controller 5, and a monitor 4. Packets of data are transmitted by a transponder on the satellite. Each transponder transmits data in a time share manner at a predetermined frequency. A tuner 21 of a decoder not shown in FIG. 1a is tuned in to the frequency of the transponder corresponding to a channel, which is designated by a viewer so that the packets of digital data are received by the decoder.

The antenna 3 receives an encoded data signal sent from a satellite. The received encoded signal is decoded by the IRD 2. The antenna 3 has a low noise block down converter 3a (LNB) not shown in FIG. 1a. The LNB 3a converts a frequency of a signal sent from the satellite to another frequency. The converted signal is supplied to the IRD 2. The monitor 4 receives a signal from the IRD 2.

A simplified block diagram of one embodiment of the system of the present invention is illustrated in FIG. 1b. This embodiment illustrates a system 100 which includes a set top box controller 104 which controls a television display 106. It is readily apparent that the system is not limited to set top boxes and televisions; rather, the system also can be embodied in other types of processor-based systems including computing systems that control displays, and recording and time delay playback systems such as TiVo, manufactured by TiVo, Inc., Alviso, Calif. (TiVo is a trademark of TiVo Inc.), and Replay TV (Replay TV is a trademark of Replay TV Inc.), manufactured by Replay TV Inc., Mountain View, Calif.

Referring to FIG. 1b, the system 100 includes a set top box controller 104, a signal sending device 102, and a display device 106. The set top box controller 105 controls the display of information such as broadcasts received from satellite transmissions and associated data. In addition, the controller 104 preferably includes a receiving function that operates to receive input from a signal-sending device in accordance with the teachings of the present invention. In one embodiment a separate logic or processor may implement the signal-sending device 102.

The incoming signal data from the signal-sending device 102 may include data such as electronic programming guide data, as well as user preferences, and including indications when a viewer expresses interest in viewing a particular program folder or category. The set top box controller 105 can be configured to include a variety of functions known to those skilled in the art in addition to those functions described herein. Furthermore, in accordance with the teachings of the present invention, the controller 104 can be configured to store selections made by a user into its memory for allowing a user to navigate back and forth from previously made selections.

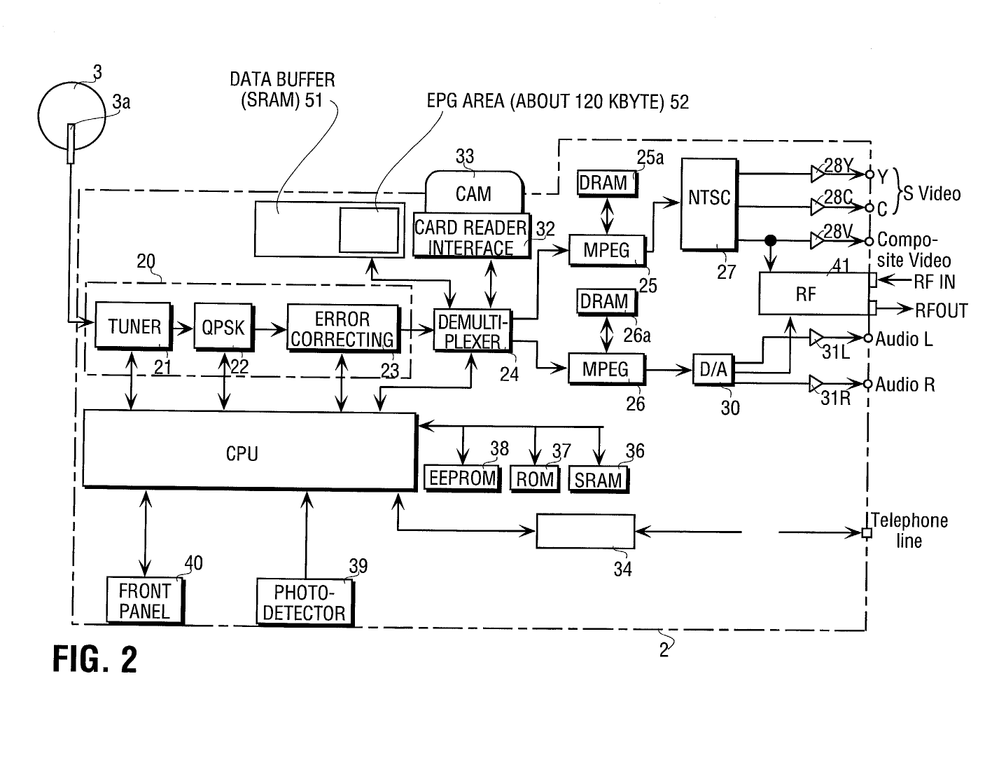

FIG. 2 is a block diagram of one embodiment of the IRD2. A radio frequency (RF) signal output from the LNB 3a of the antenna 3 is supplied to a tuner 21 of a front end 20. The output from the tuner 21 is supplied to a quadrature phase shift keying (QPSK) demodulation circuit 22 for demodulation. The output from the QPSK demodulation circuit 22 is supplied to an error correcting circuit 23 for error correction. The data is received in encrypted and encoded (i.e., compressed) form.

The transport IC 24 receives the data stream, consisting of packets of data, from the error correcting circuit 23 and directs portions of the data stream to the appropriate circuit for processing. The digital data stream sent from a satellite includes headers for classifying the different portions of the data in the digital data stream. The transport IC stores the headers in registers and uses the headers to direct the data. In the embodiment described herein, the data stream sent from the satellite includes video data in the format specified by the Motion Pictures Expert Group standard (MPEG), MPEG audio data and electronic programming guide (EPG) data. Data that is identified by its header to be video data is transferred to MPEG video decoder 25. Data that is identified by its header to be audio data is transferred to MPEG audio decoder 26. Similarly, data having a header that identifies the data to be EPG data is transferred to a predetermined area in the data buffer 51 designated to store the EPG.

A conditional access module 33, includes a central processing unit (CPU) 29, a read-only memory (ROM) and a random access memory (RAM). The conditional access module determines whether the user has the authorization to receive certain data, e.g., audio/video for a pay TV station, using the authorization information stored in its memory. Thus, if the conditional access module determines that the user is authorized access, a key to decrypt the incoming data is provided to the transport IC 24, which decrypts the data using the key provided. In one embodiment, a smart card is utilized. This card is inserted into the card reader interface 32 for interface to the transport IC 24. It is readily apparent to one skilled in the art that the conditional access module is not limited to smart cards and may be configured in other kinds of circuitry.

The MPEG video decoder 25 decodes the video signal received from the transport IC. Dynamic random access memory (DRAM) 25a, connected to the MPEG video decoder 25, is used for buffering and storage of video data during processing by the MPEG video decoder. The decoded digital video signal is supplied to a National Television System Committee (NTSC) encoder 27 and converted to a luminance signal (Y) and a chroma signal (C) which are respectively output through a buffer amplifier 28Y or 28C as an S video signal. A composite video signal is also output through a buffer amplifier 28V.

The MPEG audio decoder 26 decodes the digital audio signal. DRAM 26a, connected to the MPEG audio decoder 26, is used for buffering of data and information during processing by the MPEG audio decoder 26. The decoded digital audio signal is converted into an analog audio signal by D/A converter 30. The left audio signal is output through buffer amplifier 31L and the right audio signal is output through buffer amplifier 31R.

An RF modulator 41 mixes a composite signal output from the NTSC encoder 27 with an analog audio signal output from the D/A converter 30. The RF modulator 41 converts the mixed signal into an RF signal and outputs the RF signal therefrom.

The CPU 29 functions as a central control mechanism and executes instruction code stored in memory, for example ROM 37, to perform certain functions of the system. For example, the CPU 29 processes certain data to control the generation of the folders and resultant program list in accordance with the teachings of the present invention. In addition, the CPU 29 receives and processes the user input, received from the front panel buttons or switches 40 and the photo detector circuit 39, to provide the user functionality and access to the system as described herein. Furthermore, the CPU accesses user settings/preferences for processing of information and configuration of the system. In one embodiment, the user settings may be stored in the non-volatile memory, such as electrically erasable programmable read-only memory (EEPROM) 38.

In one embodiment, the CPU maintains a list of pointers, stored in static random access memory (SRAM) 36, to the channel information and program information stored in the SRAM 51. Thus, when a user wishes to display a form of the EPG on the screen, the CPU 29, accessing pointers stored in the SRAM 36, communicates to the transport IC 34 to retrieve the data from the data buffer (SRAM) 51 identified by the pointers. The CPU 29 then formulates the format and other digital data which forms the guide or list on the screen and forwards the data representative of the guide/list to the transport IC 34 which forwards the data to the DRAM 25a of the MPEG video decoder 25 for subsequent output to the screen.

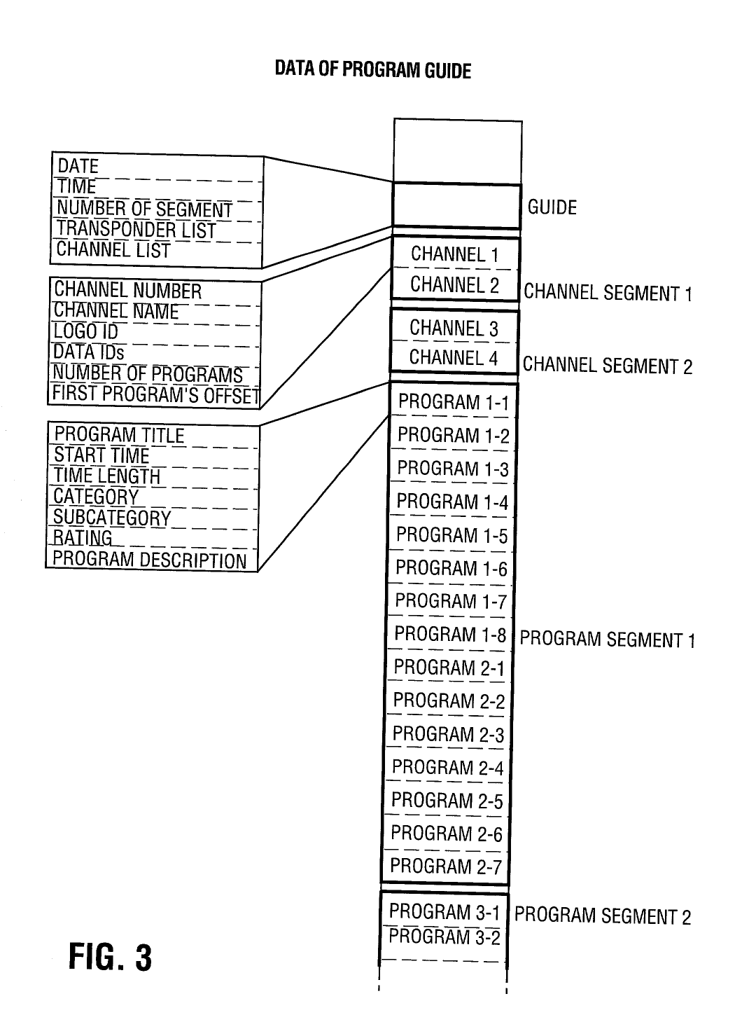

FIG. 3 is a block diagram illustration of one embodiment of the data stored in a portion of the data buffer RAM 51. As noted above, the RAM 51 stores EPG data including guide data, channel data, and program data. General information is included in the guide data, for example, the current date and time. The transponder list identifies the number of the transponder transmitting a segment. The channel list identifies the channel number of the first channel of a portion of data. The channel data includes data relating to channels, such as the channel number, channel name (i.e., the call sign of a broadcast station), logo ID (i.e., an identification of the channel logo), data ID, which is an identification of a channel number of MPEG video data or MPEG audio data, number of programs, which identifies the number of programs to be transmitted on a channel during a predetermined time frame, and first program offset which identifies the offset from the header to the first channel data in a segment.

The program data may include a variety of data related to the program such as program title, start time of the program, time length of the program, program category such as movies, news, sports, etc., program subcategory such as drama, horror, children's movies or baseball, basketball, football for the sports category, the movie rating and program description that provides a detailed description of the program. Furthermore, advertising sales and marketing data of related and unrelated merchandise may also be included.

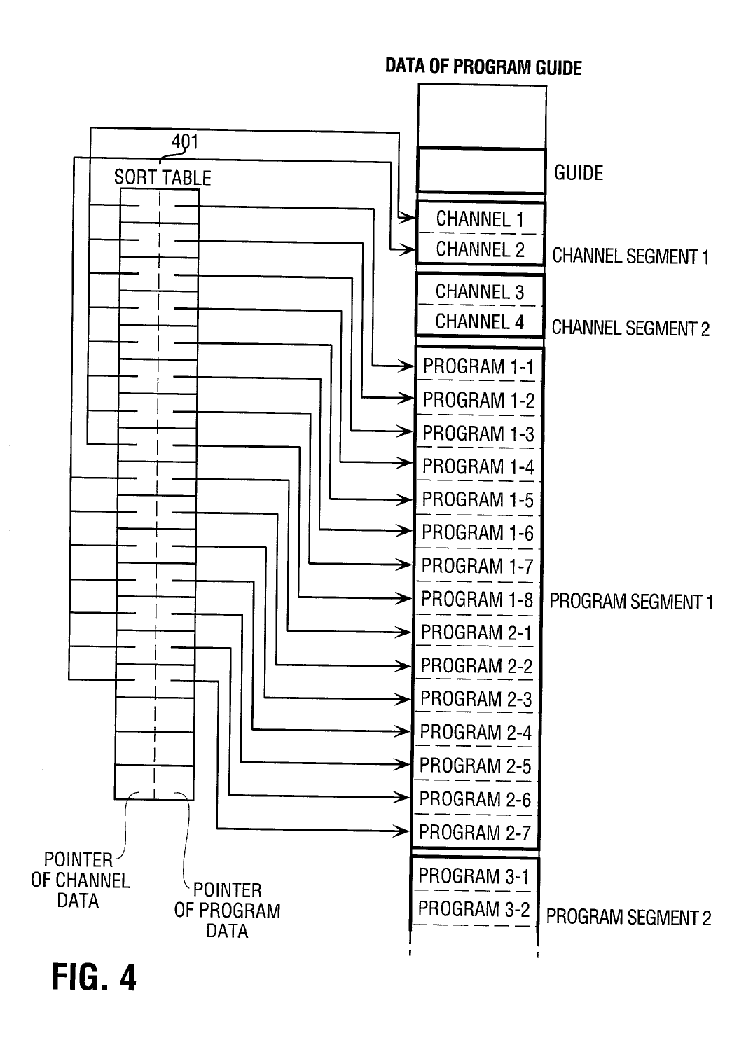

FIG. 4 illustrates one embodiment of how pointers to the EPG data are sorted for display on a guide on the user's television screen. As noted above, EPG data includes guide data, channel data and program data which are stored in the Data Buffer (RAM) of the IRD (as shown in FIG. 2). When a viewer selects a channel, the CPU 29 of the system determines the packet containing the channel information and extracts the transponder number from the channel information. The system front end starts tuning in the frequency of the designated transponder so as to receive the data transmitting from that transponder. If a viewer does not select any channel, the last channel is preferably designated.

As noted above, the CPU 29 generates a table of pointers 401 to the EPG stored in the memory. The table 401 is used for changing the order of channels or programs according to the information to be presented in the guide to the user. The table 401 includes an entry for the address pointer to the corresponding channel data and an entry to the corresponding program data.

A table for generating display information is stored in the ROM 37. Certain data from the table is read out from the ROM 37 and stored in DRAM 25a. Preferably the data is stored in compressed form. Therefore, when a character is displayed on a screen, the compressed character array is decoded so as to generate the character to be displayed. The encoder references a dictionary, which includes a set of words and frequently used portions or words and numbers corresponding to each word or portion of a word. The encoder encodes each word to each number by using the dictionary. The decoder references the same dictionary as the encoder to perform the decode function. Once decoded, each character of the decoded word includes a character code corresponding to an American Standard Code for Information Interchange (ASCII) code. Nonvolatile memory (e.g., EEPROM 38) has two tables. The first table contains character bitmaps in the different fonts available for each character. The second table identifies the address in the first table at which to extract the character bitmap. The address is determined according to the character code. The bit map image of the character is transmitted to DRAM 25a and subsequently accessed to display the character on the screen.

In one embodiment of the present invention, the channel data is received from a predetermined transponder and the channel number and channel name are stored in DRAM 25a. Additional channel information such as the channel logo is stored in the ROM 36. The ROM 36 preferably includes a table of Logo IDs and the address of Logo Data stored in ROM 36. Therefore, once a Logo ID is determined, the address of the Logo Data is determined, retrieved and stored in DRAM 25a.

The channel data provides the beginning address of the program data for a particular program. The actual location on the screen at which the program information is displayed is dependent upon the format of the guide. For example, in a time-based system, the location where the program title is displayed is determined by the start time and time length stored in the program data.

Using this information downloaded from the satellite transmission, programming and channel selection information is provided to the viewer. In the system and method of one embodiment of the present invention, this information is provided to the user in an innovative manner in order to enable the viewer to easily determine and select stations or programs to be viewed.

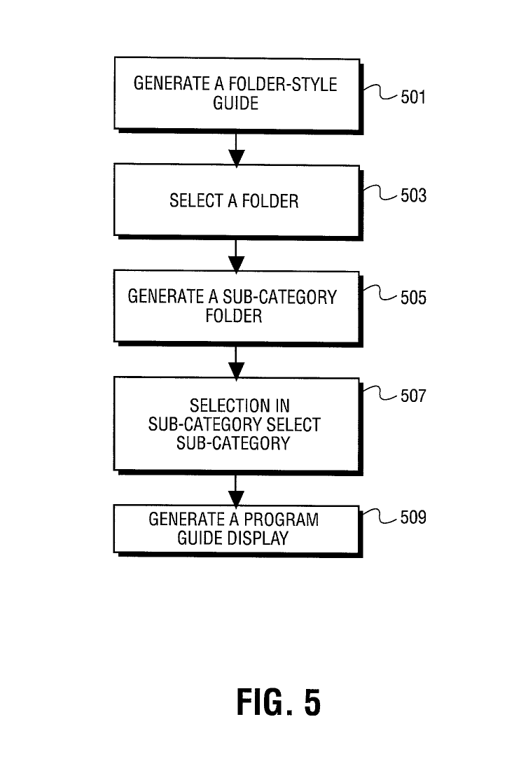

FIG. 5 is a simplified method according to an embodiment of the present invention. At step 501, a folder-style guide is generated and presented to the user. The folder-style guide may display several folders, each folder representative of a different type or category of program. In one embodiment, the designated folder may have a title that indicates the type of program in the folder such as drama, sports etc.

In some embodiments, other categories of folders may include functional aspects, such as the look of the electronic program guide that may subsequently be generated, and the selection and location of category folders to be displayed. The folder categories may also include advertising, marketing and merchandising information that may be of interest to the user.

A category folder is selected, step 503, for example, by using the system's remote control device to navigate. Once a category folder is selected, the corresponding sub-category folders are generated and displayed, step 505.

In one embodiment, the category folders are removed from the display once a category folder is selected. Alternately, the display may be reconfigured to display the category folders in one or more areas of the display and the subcategory folders corresponding to the selected category in another area of the display.

Each sub-category folder may have a title that indicates the contents of the folder. In one embodiment, the title may indicate the origin of the broadcast (e.g. different broadcast systems, networks, stations). Other sub-categories, such as more specific types of programming, may also be represented. For example, if a “sports” category folder is selected”, sub-category folders titled “golf”, “baseball”, “Olympics” and “football” may be generated on the display.

Each sub-category folder may also contain a number of sub-categories associated with the type of programming of the sub-category folder. Thus, a guide may be specifically tailored to the interests of the user by selection of the category and subcategory folder at different levels of detail.

At step 507, a sub-category folder is selected. In one embodiment, one subcategory folder may be selected. In alternate embodiments, multiple subcategory folders can be selected.

At step 509, in response to the selection of a sub-category folder, a display of category and sub-category information related to the selected sub-category folder is displayed. As noted above, in alternate embodiments, additional levels of sub-category folders may be provided such that the user can select specified criteria regarding the programming information to be received.

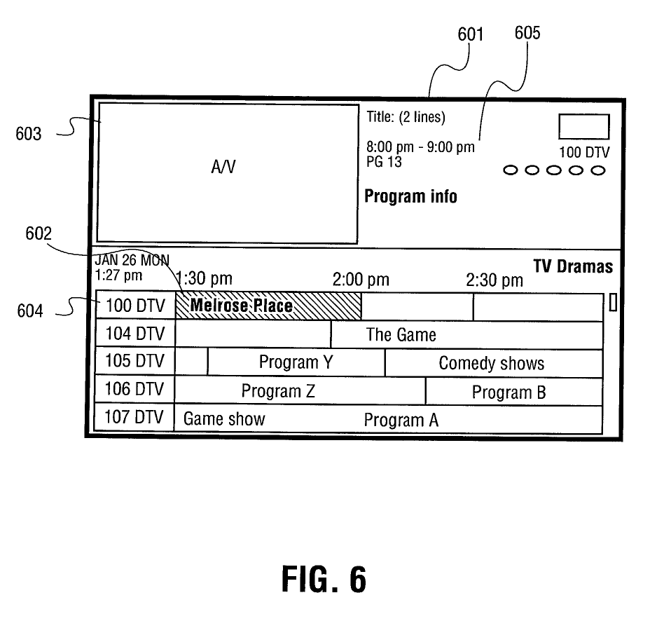

In one embodiment, the programming information is provided in the form of an electronic program guide (EPG). One embodiment of an EPG is illustrated in FIG. 6. Alternately, other embodiments, including pay-per-view displays lists and advanced programming temporal lists may be utilized.

In an alternate embodiment, program information may be stored in memory and linked to a process that monitors the current date and time, in order to generate a notification that might be required at a particular date and time. In such an embodiment, the system issues a notification and may display selected data such as folder, sub-category folder or program display information at applicable times.

In one embodiment, a user selects the desired folder style-guides, the associated category and sub-category folders, and sub-categories that may be accessed. In another embodiment, the selections may be made by a preprogrammed system, service provider or network.

Typically, the user will select the category and sub-category folders used to generate the output display, for example, the user-tailored EPG. In other embodiments, such selection process may be partially or fully automated. For example, if the user only wants to see baseball game listings when viewing the EPG, the system can be programmed to automatically select the appropriate folders. Alternately, for example, if the user only wants to see sports listings and choose later which sport, the system may be automated to automatically choose the “sports” category folder while permitting the user to select a desired subcategory folder (e.g., baseball).

Furthermore, in some embodiments, the category folders and sub-category folder may configurable. Thus, in some embodiments, the category and subcategory folders may be created and deleted by a user, service provider, preprogrammed system, etc. The ability to configure may be partial, for example, a user may only be able to configure sub-category folders, or more complete, for example, all category and sub-category folders. The creation and deletion options may also be restricted to a particular user, service provider, network etc. For example, a password or other some other user recognition may be required for entering, creating or deleting category folders or sub-category folders.

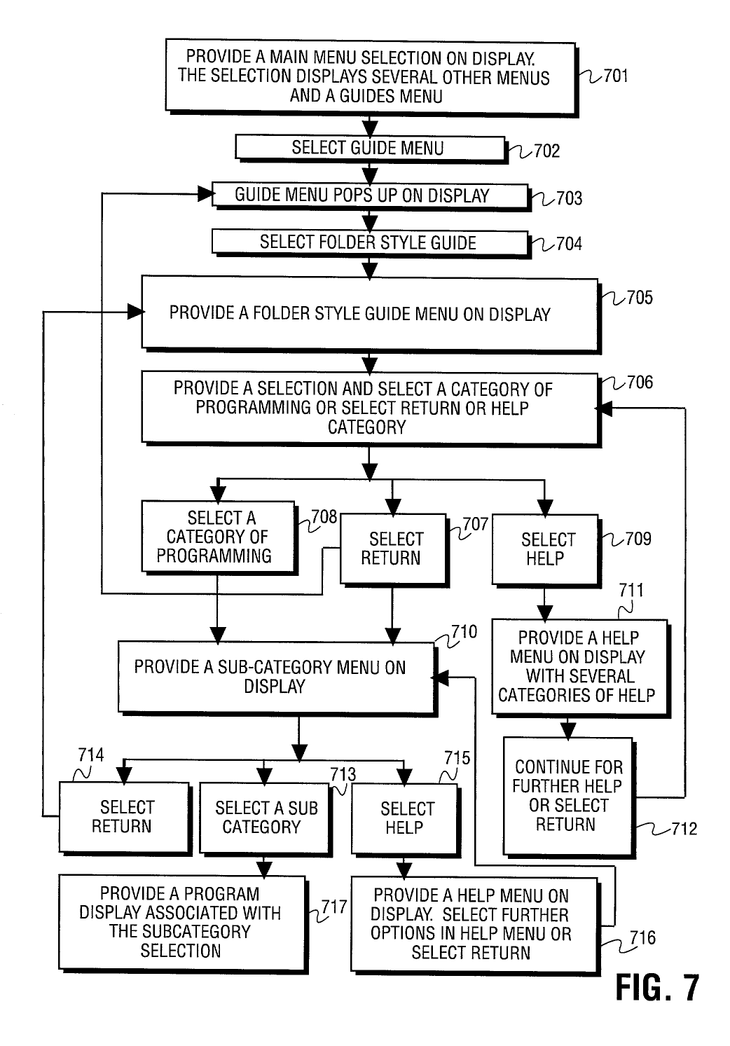

FIG. 7 is a flow diagram illustrating an alternate embodiment of a process for generating a display in accordance with the teachings of the present invention. At step 701, a main menu may be provided on display for selection. The main menu may contain several other menus one of which is the guide menu.

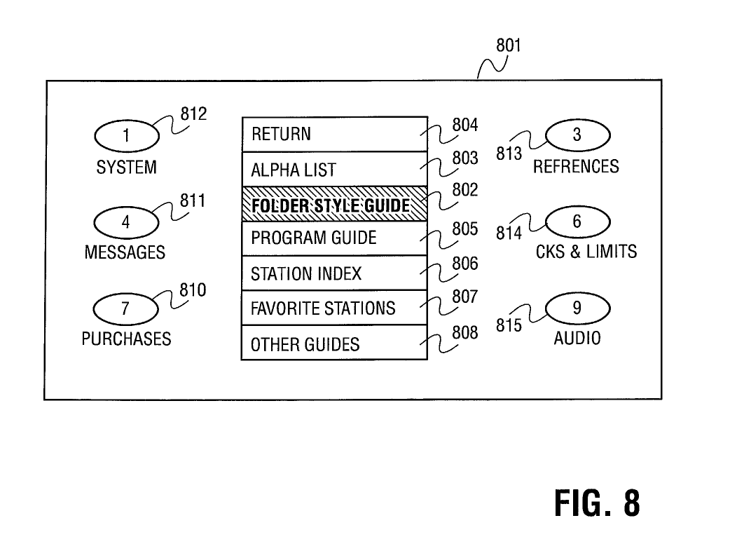

Once the Guide Menu is selected, step 702, the Guide Menu is displayed, step 704. One embodiment of a Guide Menu is illustrated in FIG. 8. The Guide menu 801 may contain a number of guides as well as other features. The visual display design of a guide menu may be designed in several styles, as desired.

For example as shown in FIG. 8, some design features may include a return feature 804, an alpha list feature 803, folder style guide 802, a program guide 805, station index 806, favorite station feature 807 as well as other guides 808 generated for a particular application. The guide menu may also include options for purchasing 810, audio 815, messages 811, references 813, etc.

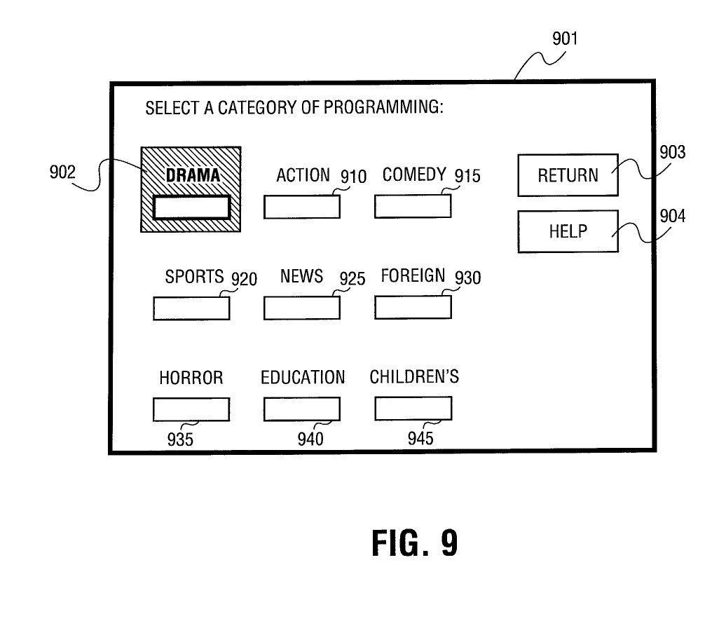

Referring back to FIG. 7, at step 704 a folder-style guide is selected. The selection of the folder style-guide at step 704 provides a folder-style guide to be displayed, step 705. The visual design of the folder-style guide may vary and be designed in several styles as desired. One example is shown in FIG. 9. In this embodiment, the folder style guide menu 901 provides several folders (for example, folders 902, 910, 915, 920, 925, 930, 935, 940, 945), each folder representing a category of programming. The folder-style guide 901 enables a selection of at least one folder and its associated category of programming, step 706. In this embodiment, the folder style-guide 901 also contains a return 903 and a help 904 feature that enables the user to return to the prior window or folder and receive help, respectively.

Referring back to FIG. 7 and the embodiment illustrated in FIG. 9, at step 706, a selection is made. For example, a selection may be made by selecting the return feature, step 707. This selection may take the user back to the guide menu and allow a guide menu to be displayed for selection step 703. Alternately, at step 709, a selection may be made by selecting the help feature. At step 711, this selection may provide further help features in a menu that is displayed. The menus may contain several categories of help and be configured to allow a user to navigate to an area of help desired. The help feature may also contain a return feature that may be selected to return back to the folder-style guide 901.

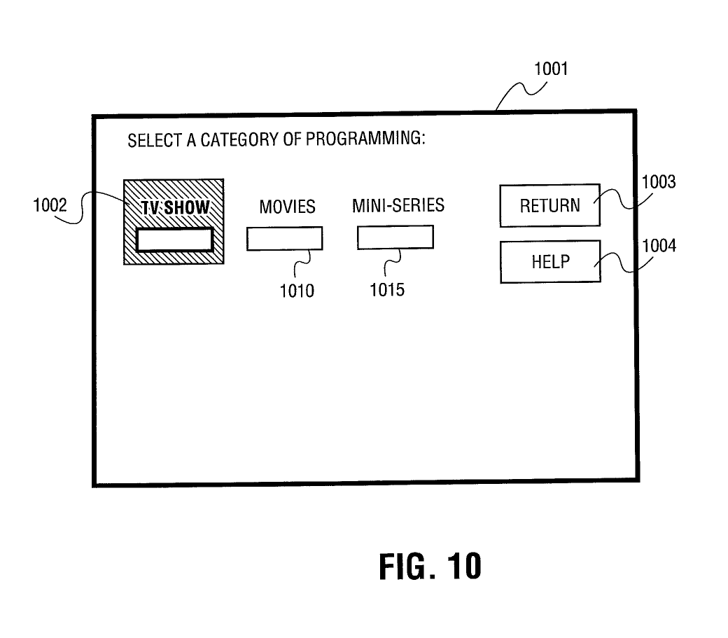

At step 708, a selection may be made by selecting a folder associated with a category of programming. As shown in operation 708, this selection may provide a sub-category folder to be displayed, step 710. The visual display design of the sub-category folder may vary and be designed in several styles as desired. For example in one embodiment, the sub-category folder may be designed as shown in FIG. 10. The sub-category folders selection may provide several sub-category folders with each sub-category folder representing a category of programming and configured to allow for a selection of at least one sub-category to be made.

Referring back to FIG. 7, in the present embodiment, at step 713, a selection is made by selecting a folder associated with a sub-category of programming. At step 717, a program guide is generated associated with the sub-category selection to be displayed. The visual display design of the program display may vary and be designed in several styles as desired. For example in one embodiment, the program display 601 may be designed as shown in FIG. 6. In one embodiment, the program guide generated from the selected folders highlights those programs meeting the select category criteria and sub-category criteria.

For example, a user may select a Drama category folder 902 as shown in FIG. 9. As shown in FIG. 10, this selection may provide several subcategory folder 1002, 1010, 1015 related to Drama. The sub-categories may be sub-topical, e.g. Drama-Television, Drama TV and Drama mini-species. Alternately, or additionally, sub-categories may be related to other types of subcategories, such as time, for example, program duration, start time or end time.

A user may select any one of the sub-categories to display all the programs related to that sub-category. For example a user may select Drama Movies to display an information display of movies related to drama.

The program display, for example, FIG. 6, generated can provide program detail of selections. Program details may include an audiovisual display showing a short clip, advertisement etc., corresponding to selected program(s) or category(ies)/sub-category(ies) on the program display. Program details may also include the program title selected, start and end times of the program selected, channel, date and time of showing of the program selected and any other program information.

The information display may be designed and configured in several ways as desired. For example in one exemplary embodiment the EPG may be used to effect an action on a future program. There are many actions that a user may desire to take in regards to a future program. The user may wish to select a future program and then be notified when the program is available, or the user may wish to set a recording device to record the future program, or perhaps the user may desire to block the display of a future program. These and other actions may be set by the user to affect a future program.

What is claimed is:

1. A method for generating an electronic program guide on a display device comprising generating a folder-style guide comprising:
generating at least one category folder, said at least one category folder generated on a display;
selecting one or more at least one category folders from said folder guide displayed;
generating on the display at least one sub-category folder for each selected at least one sub-category folder;
selecting at least one sub-category folder; and
generating an electronic program guide in accordance with the at least one sub-category folder selected.

2. The method as set forth in claim 1, wherein categories of category folders in said folder guide are selected from the group consisting of drama, sports, news, comedy, action, foreign, horror, education and children.

3. The method as set forth in claim 1, further comprising modifying the folder style guide, said modifying selected from the group consisting of adding types of category folders, adding types of sub-category folders, adding types of programs, removing types of category folders, removing types of sub-category folders, removing types of programs, wherein said category of said folder in said folder guide being a type of category that may be created by a service provider or user, and said user or said service provider being able to add and delete folder categories at anytime.

4. The method as set forth in claim 1, wherein the display from selecting said sub-category-folder comprises a return feature, said return feature selectable by a user, said selecting said return feature allowing a user to navigate back to a sub-category-folder previously selected.

5. A computer readable medium comprising instructions, which when executed by a processing system, perform a method for generation of a folder-style guide comprising:
generating at least one category folder, said at least one category folder generated on a display;
selecting at least one category folder from said folder guide displayed;
generating on the display at least one sub-category folder for each selected at least one sub-category folder;
selecting at least one sub-category folder; and
generating an electronic program guide in accordance with the at least one sub-category folder selected.

6. The machine-readable medium as set forth in claim 5, further comprising instructions, which when executed by a processing system, perform the steps of modifying the folder style guide, said modifying selected from the group consisting of adding types of category folders, adding types of sub-category folders, adding types of programs, removing types of category folders, removing types of sub-category folders, removing types of programs, wherein said category of said folder in said folder guide being a type of category that may be created by a service provider or user, and said user or said service provider being able to add and delete folder categories at anytime.

7. The machine-readable medium as set forth in claim 5, wherein the display in response to selecting said sub-category-folder comprises a return feature, said return feature selectable by a user, said selecting said return feature allowing a user to navigate back to sub-category-folder previously selected.

8. A folder-style guide comprising:
at least one category folder; said category folder being associated with a type of programming, at least one sub-category folder within said category folder, said subcategory folder being associated with a type of sub-category of programming of one type of programming of the category folder; and
a display of programming associated with the at least one sub-category folder and displayed in response to a selection of a selected category folder of the at least one sub-category folder.

9. The folder-style guide of claim 8, wherein categories of category folders in said folder guide are selected from the group consisting of drama, sports, news, comedy, action, foreign, horror, education and children.
